(19) United States
(12) Patent Application Publication
(10) Pub. No.: US 2006/0228203 A1
(43) Pub. Date: Oct. 12, 2006

(54) Method for the takeover and/or handover and for the transport of goods

(76) Inventors: Jurgen Baumle, Bad Sackingen (DE); Bernd Elchler, Eschenbach (CH); Stefan Hultsch, Oberentfelden (CH); Frank Obschonka, Neckartenzlingen (DE); Andreas Reinhard, Sarmenstrof (CH)

Correspondence Address: BACHMAN & LAPOINTE, P.C., 900 CHAPEL STREET, SUITE 1201, NEW HAVEN, CT, 06510, US

(21) Appl. No.: 10/552,006

(22) PCT Filed: Apr. 1, 2004
(86) PCT No.: PCT/EP04/03463

§ 371 Date: May 15, 2006

(30) Foreign Application Priority Data
Apr. 4, 2003 (DE) 103 15 740.9
Jun. 27, 2003 (DE) 103 29 133.4

(51) Int. Cl. B65G 47/90

(52) U.S. Cl. 414/626

(57) ABSTRACT

A method for the takeover and/or handover and for the transport of goods, especially for the paperless commissioning of goods that are present in a stockroom by means of a vehicle that moves past storage aisles and calls at a predetermined pick location in a completely automatically controlled manner, marks a good with light and then takes over or hands over the good, the takeover or handover also being completely automatically controlled.

### BACKGROUND OF THE INVENTION

(1) Field of the Invention

The invention relates to a method for picking up and/or transferring and transporting, in particular for paperless order picking of, goods which are located in a store, by means of a vehicle which moves along storage aisles, the vehicle traveling to a predetermined pick location under fully automatic control and picking up or transferring goods there.

(2) Prior art

Nowadays, goods are often stored temporarily in enormous warehouses. They can remain on appropriate transport pallets or else be transferred into storage racks. As a rule, storage aisles, in which the transport of the goods is carried out, are formed between the storage racks.

In order to transport goods of any desired type, loading vehicles are known, such as forklift trucks or storage and retrieval devices. These are provided with a load fork to be moved underneath pallets. By means of a lifting device, the pallet is lifted and lowered at the desired point. This requires a great deal of personnel and thoughtful activity, which is not suitable for the level of automation of sequences which is desired nowadays.

In addition, order picking, that is to say the assembly of a job which comprises different positions with different articles, is mostly carried out on a pallet which lies on the forks of a forklift truck.

DE 92 17 875 U discloses, for example, a drag chassis for a loading vehicle which is detachably coupled to a driver bar via a drawbar, the driver bar having a connection to a self-propelled electrical chassis on a rail. In this way, at least this loading wagon is moved to a specific, predefined point without any additional personnel.

EP 1 407 983 A1 discloses an apparatus for picking up and transporting pallets. Two lines lying immediately beside each other are provided for picking up, transporting and storing pallets and are served by substantially functionally identical apparatuses which are located beside one another and which can be operated synchronously.

U.S. Pat. No. 4,950,119 reveals a system for transporting, storing and removing goods in the warehouse. This is done by using a suspended track, which moves to an appropriate pick location.

A method of the above-mentioned type is disclosed by DE 38 26 518 A1. There, a traveling table removes a selected box from storage racks in an electromagnetic way, places said box on the weighing table, the current weight of the box content being measured and passed on to a computer unit, at the same time the selected box being brought to the counter, where the ordered article can be removed, the balance checking the new weight of the box and passing this on to the computer unit.

### SUMMARY OF THE INVENTION

The present invention is based on the object of developing a method and a system of the aforementioned type with which picking up and/or transferring goods, paperless assembly of a task and transporting goods in a store is substantially accelerated, carried out more correctly and implemented with fewer personnel.

In order to achieve this object, this pick-up or transfer is controlled fully automatically at the pick location, by the weight and the quantity of the goods picked up or transferred being determined on the vehicle and being compared with a desired value.

This means that the vehicle is given a specific task by a central station, directly or indirectly by means of manual entry, in order to pick up goods, for example in accordance with an order picking task, or to supply goods to specific points. This can be done by an order picker, but the vehicle could also be assigned a robot device which carries out the pick-up or transfer.

The control of the pick-up or transfer is important. The control is carried out via the weight of the goods, the difference in weight before and after the transfer of the goods being determined. This difference is compared with a desired value. If the difference agrees with this desired value within a specific range, the pick-up or transfer can be confirmed. This also applies similarly to the control of the quantity of goods picked up or transferred.

In a preferred exemplary embodiment, the pick location is to be indicated by the vehicle. For simplicity, the indication is carried out by being illuminated from the vehicle, so that the order picker knows immediately which goods he has to pick up or to where he has to transfer the goods. The number, the designation, and further details of the product are displayed on the display of the terminal carried along on the vehicle. This function can also be performed by a compartment indicator in the rack.

The vehicle beneficially provides a pick-up or transfer plane for the goods which is adjustable vertically. Here, the intention is primarily to take account of beneficial working ergonomics, so that the transfer and pick-up, if possible, are carried out at the same height. Provision is made here for the vehicle to have a device by means of which the height of the location at which the goods are located is determined.

Although all possible vehicles appear to be suitable for implementing the method of the invention, many of the tasks set can be fulfilled with the aid of an electric overhead suspended track, in particular. Along the storage aisle there extends a rail, along which vehicles of an electric overhead suspended track can move. On the vehicles of the electric overhead suspended track there are, for example, a weighing device and in particular a terminal for controlling the results and for displaying the predefinition for the pick-up or transfer of the goods.

The electric overhead suspended track has the advantage that damage to the stored goods and buildings is ruled out by the rail-bound travel. As a result of the principle of the electric overhead suspended track, the vehicle does not need any driver. The latter can thus concentrate exclusively on order picking and further does not have to accompany the vehicle on its travel, as is the case in conventional driver systems, but is able to process all picking tasks which arise in a free selectable zone. He does this by “commuting” between two or more vehicles or moving along with one or more vehicles. As a result, the proportion of travel of the order picker is reduced considerably as compared with conventional systems and the picking performance is increased accordingly.

Of course, provision can be made for a plurality of vehicles of an electric overhead suspended track, which are given a task at the same time, to be under way in the store, so that a plurality of tasks can also be processed at the same time. All the tasks are then brought together again at the end to form an order. The order picking performance itself can of course be increased by means of additional order pickers.

All the traveling movements are preferably controlled and monitored via a central controller, but it is also possible for each vehicle to be controlled individually. The vehicle control can be carried out in accordance with the loading, the acceleration and the speed in curves and on straight lines being matched to the loading, in order to configure the transport to be as gentle as possible.

Because of the terminal which is carried along and which is preferably connected directly to the store management system, paperless, good implementation and control of all order picking tasks is possible.

As additional functions, the vehicle of the electric overhead suspended track can also take with it empty pallets which accumulate, pallet packages which accumulate and the order picker. In addition, automatic checking of the pallet dimensions can be carried out.

In relation to the safety of the order picker and other persons in this region, the vehicles are equipped with a mechanical, optical, electrical or electronic protection device. This protective system automatically monitors the vehicle and secures it. The intention is for persons or objects to be detected and for the vehicle to be brought automatically to a stop. The dimensions of protective system and protective area are determined by the vehicle width, the lateral offset when traveling through a curve, the speed, the stopping distance and the response time.

With the method and system according to the invention, fully automatic loading and unloading of pallets can be carried out. The electric overhead suspended track ensures gentle transport of the pallets, even of unsecured pallets; it is to be emphasized that the pallets, once loaded, are not transferred again until they are unloaded.

One important advantage resides in the reduction in the order picking errors because the vehicle moves exactly to the pick location, illuminates the pick location or activates a compartment indicator, indicates the number of articles to be picked and checks this by means of a weighing. As a result of the single-stage order picking, that is to say from the storage unit directly to the dispatch unit, the order picking sequence is substantially simplified.

Communication between order picker and storage management is ensured continuously via the terminal that travels concomitantly.

The system is constructed simply, clearly and correctly in terms of safety, it ensures a secure function, the ability to be operated easily and operationally reliably, good accessibility and replaceability in the event of maintenance and service, and also low-noise conveying operation.

### BRIEF DESCRITION OF THE DRAWINGS

Further advantages, features and details of the invention emerge from the following description of preferred exemplary embodiments and also by using the drawing, in which:

FIG. 1 shows a schematically illustrated side view of a system according to the invention for picking up and/or transferring and for transporting goods in the use position;

FIG. 2 shows a plan view of a vehicle for picking up and/or transferring and for transporting goods.

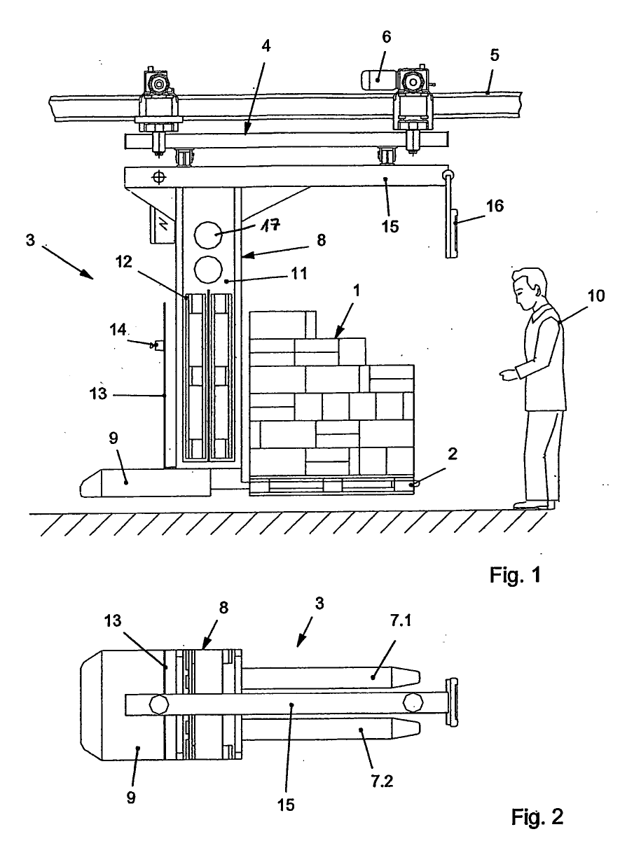

### DETAILED DESCRIPTION OF THE PREFERRED EMBODIMENT(S)

The core of a system according to the invention for picking up and/or transferring and for transporting goods 1 which are located on a pallet 2 is a vehicle 3 belonging to an electric overhead suspended track (monorail vehicle) having a load-lifting means. This vehicle 3 moves on a rail 5 and is equipped with a drive. The rail 5 leads along storage aisles, not specifically illustrated, in a store.

Electric overhead suspended tracks of this type are known and commercially available, for which reason a more detailed description will be dispensed with. For example, DE 92 17 875 shows a drag chassis which comprises a loading wagon which is detachably coupled to a driver bar via its drawbar, the driver bar having a connection to a self-propelled electrical chassis on a rail.

The load-lifting means of the vehicle 3 has two forks 7.1 and 7.2, which can be moved into corresponding recesses in the pallet 2. By using these forks 7.1 and 7.2, the pallet 2 can be lifted. For this purpose, the forks 7.1 and 7.2 are arranged on a vehicle column 8, along which they can be displaced vertically. Alternatively, the forks 7.1, 7.2 can be replaced by conveying units (roller, chain or belt technology) or by a platform.

On the vehicle column 8 there is also a footplate 9 on which, for example, an order picker 10 can travel with it.

Furthermore, appropriate compartments 11 for holding empty pallets 12, for example, are provided on the column 8.

In addition, a mounting 13 for an emergency stop switch 14 is also assigned to the footplate 9.

The vehicle column 8 is suspended on a crossmember 15, via which the vehicle 3 is connected to the carriage 4. At the end, there is on the crossmember 15 a terminal 16 having an appropriate display and a fork element.

In the vehicle column, containers 17 for waste to be disposed of (for example packaging) can also be accommodated.

The functioning of the present invention is as follows:

For example, the system according to the invention is intended to be used for the order picking of goods. To this end the vehicle 3 is given an appropriate task, it being possible for this to be done directly from a central station or else, for example, by means of an entry into the terminal 16.

This order picking task can then be divided up in accordance with an extremely wide range of points of view by a program in the terminal 16 or else by the central station, the order of the goods to be picked up being defined in accordance with their position in the order picking region.

As soon as the vehicle has received the task, it moves to the first position and can then begin with the actual order picking. The goods are preferably indicated by the vehicle itself, which can be done, for example, by means of illumination. The order picker 10 can then remove the goods from the store and place them on the pallet 2. In the process, the terminal 16 indicates to him the number of articles of the goods. For the purpose of control, it is also possible for name, article number, goods code and other important features to be indicated on the terminal 16.

A scanner can also be used as an identification or control of the picking task.

After the order picker has carried out the picking task, it is possible for a weighing of the pallet 2 including the goods 1 to be carried out (by differential measurement) for the purpose of control.

The picking task has been completed if the order picker 10 and/or the terminal finds the weighing to be in order and confirms this. The vehicle moves automatically to the next pick location of the task following confirmation. Changes to the picking task (missing quantities, breakages and so on) can be entered at the terminal 16 itself.

1-15. (canceled)

16. A method for picking up and/or transferring and transporting, in particular for paperless order picking of, goods which are located in a store, by means of a vehicle which moves along storage aisles, the vehicle traveling to a predetermined pick location under fully automatic control and picking up or transferring goods there, characterized in that this pick-up or transfer is controlled fully automatically at the pick location, by the weight and the quantity of the goods picked up or transferred being determined on the vehicle and being compared with a desired value.

17. The method as claimed in claim 16, wherein the pick location is indicated by the vehicle.

18. The method as claimed in claim 17, wherein the pick location is illuminated.

19. The method as claimed in claim 16, wherein a pick-up or transfer plane for the goods is adjusted vertically automatically in accordance with a storage height to be determined by the vehicle.

20. The method as claimed in claim 16, wherein the vehicle takes with it empty supports or containers for the goods, waste, pallet securing means or the like and/or also provides the opportunity for the order picker to travel with it.

21. A system for a method as claimed in claim 16, wherein at least to some extent, a rail guide which is used to guide an electric overhead suspended track is provided in the storage aisles.

22. The system as claimed in claim 21, wherein the electric overhead suspended track is assigned a weighing device and a terminal for controlling the weighing results.

23. The system as claimed in claim 21, wherein the electric overhead suspended track forms a pick-up or transfer plane for the goods.

24. The system as claimed in claim 23, wherein the pick-up or transfer plane is formed by two forks conveying technology or a platform.

25. The system as claimed in claim 23, wherein the pick-up or transfer plane can be adjusted vertically.

26. The system as claimed in claim 21, characterized in that the vehicle has a concomitant travel plane for an order picker.

27. The system as claimed in claim 21, characterized in that the vehicle has an identification means for indicating the goods to be removed or activates a compartment indicator.

28. The system as claimed in claim 21, wherein the vehicle is equipped with a protective device for monitoring and securing the vehicle.
